(19) United States
(12) Patent Application Publication
(10) Pub. No.: US 2007/0067074 A1
(43) Pub. Date: Mar. 22, 2007

(54) RECONFIGURABLE ALGORITHMIC NETWORKS IMPLEMENTED VIA A FLIGHT DATA RECORDER

(75) Inventors: Scott D. Lykken, North Bend, WA (US); Wendell A. Frost, Renton, WA (US); Kevin S. Pogge, Kent, WA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/161,870

(22) Filed: Aug. 19, 2005

(51) Int. Cl. G06G 7/70

(52) U.S. Cl. 701/16

(57) ABSTRACT

A flight data recorder system containing an aircraft condition monitoring function which includes a reconfigurable algorithmic network which defines operations on a set of flight data along with interpreters to analyze the flight data. The reconfigurable algorithmic network accepts flight data from a variety of sources. The reconfigurable network defines functional relationships between various flight data and performs operations on the various flight data. The flight data sources and the relationships therebetween can be configured by the user. The reconfigurable algorithmic network allows customization of a flight data analysis function without the need to recertify operational software.

### BACKGROUND OF THE INVENTION

The advent of digital flight data systems, which can utilize as many as 20,000 different flight parameters from sensors in a commercial aircraft, has provided aircraft operators as well as flight crews with the opportunity to obtain data on a wide variety of operational, maintenance and flight safety matters. The availability of this data has proven to be very useful in the operation of commercial aircraft. However, different operational groups within an airline frequently have different requirements as far as types of flight data that they find useful as well as the manner in which the data is analyzed, displayed and reported. For example, an Operations Department might find data related to airspeed, altitude and airplane position particularly useful whereas maintenance personnel might be more interested in data related to engine and electrical systems. In addition, each operator tends to have its own unique requirements and uses for flight data.

Because of the shear magnitude of flight data that is available and the differing requirements of airlines as well as groups within the airlines, providing this data in a useful form has become an expensive and time consuming task. Currently, not only is it necessary to create separate data handling computer programs for each group utilizing this flight data, but this process is further complicated by the fact that different types of computer hardware are often used by these groups. As an example, data management units or flight data recorders designed for aircraft installation normally utilize an entirely different microprocessor and operating system than ground based workstations that typically use a personal computer with the Windows® operating system. To further complicate the situation, it is a requirement of governmental flight regulation authorities, such as the U.S. Federal Aviation Administration, that software used with commercial aircraft must be officially certified. Not only must the original programs be certified, but in most instances any time a change is made in a program, the program must be recertified. This substantially increases the expense as well as the time required to create and modify data analysis software for use with flight data in an airborne application.

Many large commercial aircraft include a Flight Data Acquisition System with an Aircraft Condition Monitoring Function (ACMF) for analyzing and processing flight data. An example ACMF is an Interpreter program that is associated with a reconfigurable algorithmic network (RAN) as described by example in U.S. Pat. No. 5,761,625. The RAN has resolved a number of the software update problems as noted above. However, in some aircraft cost or space prohibits installation of both a Flight Data Recorder and a Flight Data Acquisition System containing an ACMF.

Therefore, there exists a need to provide the benefit of a RAN when cost or space considerations exist.

### BRIEF SUMMARY OF THE INVENTION

The present invention provides an aircraft condition monitoring function that can be used within a flight data recorder. The use of a RAN allows customization of the flight data analysis function without the need to recertify operational software. The flight data recorder uses a reconfigurable algorithmic network to define operations on a set of flight data along with interpreters to analyze the flight data in accordance with the reconfigurable algorithmic network. Individual operations on flight data are represented by functional elements connected together to define the operational relationships between the functional elements.

A development system includes a display for use with an aircraft data management system for developing reconfigurable algorithmic networks where functional elements of the network are represented on the display by element symbols and are connected together by data lines, which represent the functional relationships between the functional elements in the network. The color of the data lines can be used to represent data types. Various element symbols can be used to represent flight data parameter sources, data and logic operations, timer and counter operations and report generators. Construction of the network can be facilitated by displaying a palette of element symbols and using a mouse for point and click operations to select element symbols for the network from the palette and connecting the selected symbols by drawing data or connection lines between the symbols.

### BRIEF DESCRIPTION OF THE SEVERAL VIEWS OF THE DRAWING

The preferred and alternative embodiments of the present invention are described in detail below with reference to the following drawings:

FIG. 1 is a block diagram illustrating an aircraft condition monitoring function implemented on a flight data recording system according to the invention;

FIG. 2 is flow diagram illustrating the operation of an interpreter used in the flight data recording system of FIG. 1;

FIG. 3 is a view of a screen display of a reconfigurable algorithmic network for use with the data recording system of FIG. 1;

FIG. 4 is a screen display of a parameter input/output window for use in the development of the reconfigurable algorithmic network of FIG. 3;

FIG. 5 is a screen display of a report format window for use in the development of the reconfigurable algorithmic network of FIG. 3; and

FIG. 6 is a screen display of the reconfigurable algorithmic network of FIG. 3 illustrating the use of a compressed reconfigurable algorithmic network.

### DETAILED DESCRIPTION OF THE INVENTION

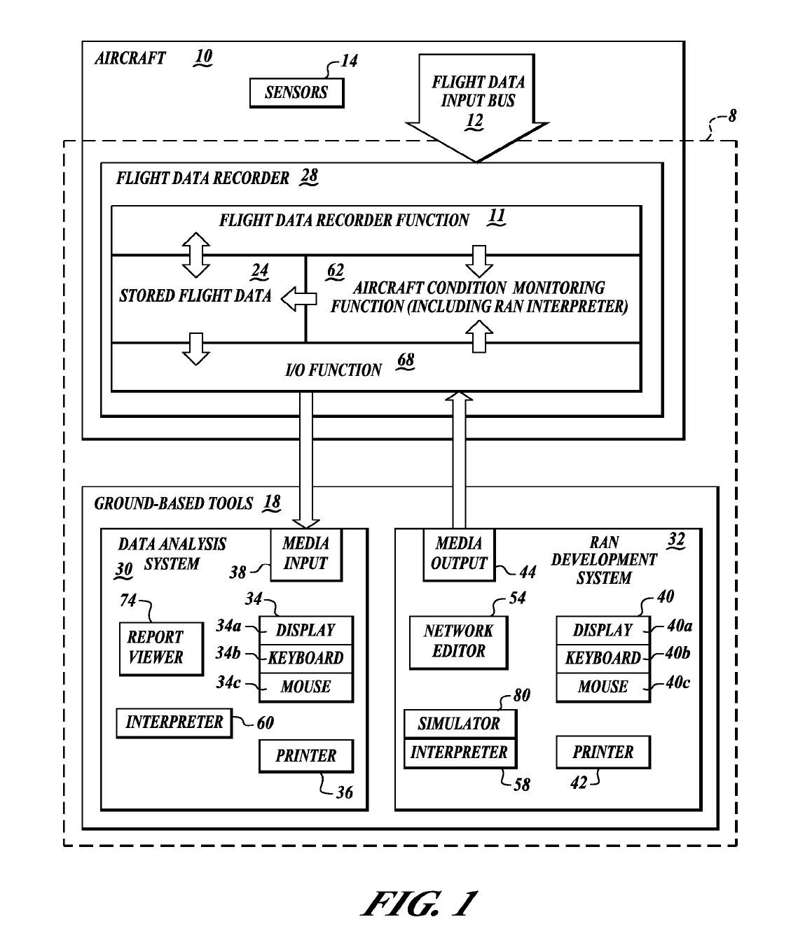

FIG. 1 provides, in block diagram form, an illustration of the preferred embodiment of an aircraft flight data recording system 8 for use with an aircraft 10 according to an embodiment of the invention. As is typical of modern commercial aircraft, a serial digital data bus 12 is used to transfer data to a flight data recorder 28. Optionally, certain flight data recorder systems may include a set of sensors 14 directly connected to the flight data recorder 28, for generating flight data such as airspeed, altitude, control surface positions and engine conditions. The flight data recorder 28 includes a recording function component 11 to acquire the flight data and manage the data storage, a reconfigurable algorithmic network (RAN) interpreter to perform the aircraft condition monitoring function (ACMF) component 62 and an input/output function component 68 to allow offload of recorded flight data and upload of new RANs.

A ground-based portion 18 of the data management system 8 includes a flight data analysis system 30 and a RAN development system 32. The analysis system 30, which can be implemented in a personal computer or a computer work station, includes a user interface 34, typically having a monitor display 34A, a keyboard 34B and a mouse 34C, a printer 36 and a media input device 38 for receiving various types of data media such as floppy disks, PCMCIA cards or other data transfer media. The development system 32, which also can be implemented in a personal computer or a computer work station preferably using the Windows® operating system, includes a user interface 40 having a monitor display 40A, a keyboard 40B and a mouse 40C along with a printer 42 and a media output device 44 similar to the media input device 38.

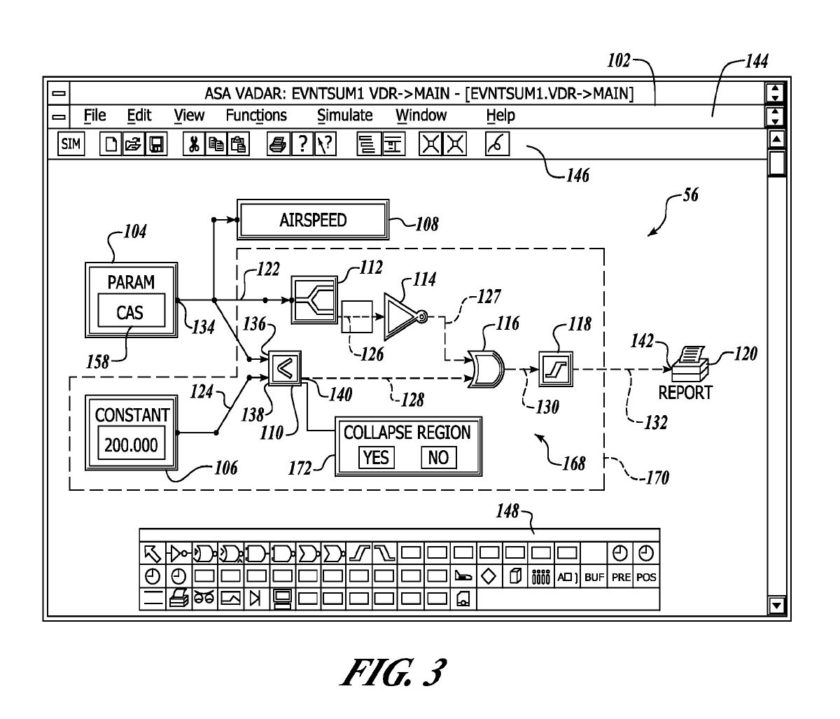

In order to provide for efficient and flexible data acquisition and recording of the some 20,000 different types of flight data that can be produced by the sensors 14 on the aircraft 10, the development system 32 includes a network editor 54 software program, which is used to develop a series of RANs. One of the purposes of the RANs is to define a set of operations to be performed on selected flight data obtained from the sensors 14 and to format reports that will display the results of the operations on the data once it has been processed. Operation of the network editor 54 in the creation of the RANs is explained in detail in connection with FIGS. 3-6. After the RAN has been created, it is interpreted in conjunction with the selected flight data by an interpreter program such as a development system interpreter 58 located in the development system 32, a reporting system interpreter 60 located in the reporting system 30 or a data management unit interpreter (RAN interpreter located in the ACMF component 62 of the flight data recorder 28). In this embodiment, each of the interpreters 58 and 60 and the interpreter in the ACMF component 62 are capable of interpreting the RANs 56 but can be designed to run on different computer hardware systems. For example, the reporting system interpreter 60 could be written to run on an Intel microprocessor using a Windows® operating system while the interpreter in the ACMF component 62 would be written to run on different microprocessor in the flight data recorder 28.

One of the primary advantages of this approach is that the RANs, which define data management operations, are hardware independent. Also, this approach can substantially reduce certification requirements because once the interpreters 58 and 60 and the interpreter in the ACMF component 62 are certified for particular computer systems such as the flight data recorder 28, and because merely interpreting the RAN does not affect the operational software in the recorder 28 on the aircraft 10, it should not be necessary to obtain recertification every time the RAN is modified or a new RAN is created.

There are a wide variety of uses for the ACMF component 62. For example, one of the RANs can be created in a network editor 54 in the RAN Development System 32 and transmitted to the media output device 44 and then, hand carried on a floppy disk or PC-card to the aircraft 10 where it is loaded through a recorder I/O function component 68 directly into the flight data recorder 28. After the RAN is interpreted by the interpreter in the ACMF component 62, a resulting report is stored in memory 24 of the data recorder. The stored report can then later be extracted from the recorder 28 through the recorder I/O function component 68 and hand carried to the media input device 38 and transmitted to a report viewer program 74 in the reporting system 30 for display on the user interface 34 or printing on the printer 36.

To aid in the development of the RANs, the development system 32 preferably contains a simulator program 80 that includes a data base of simulated flight data (not shown.) The interpreter 58 tests and debugs the RAN as it is being developed. It should also be noted that the development system 32 can distribute the RANs directly to one or more of the reporting systems 30 by using a digital network such as a local area network.

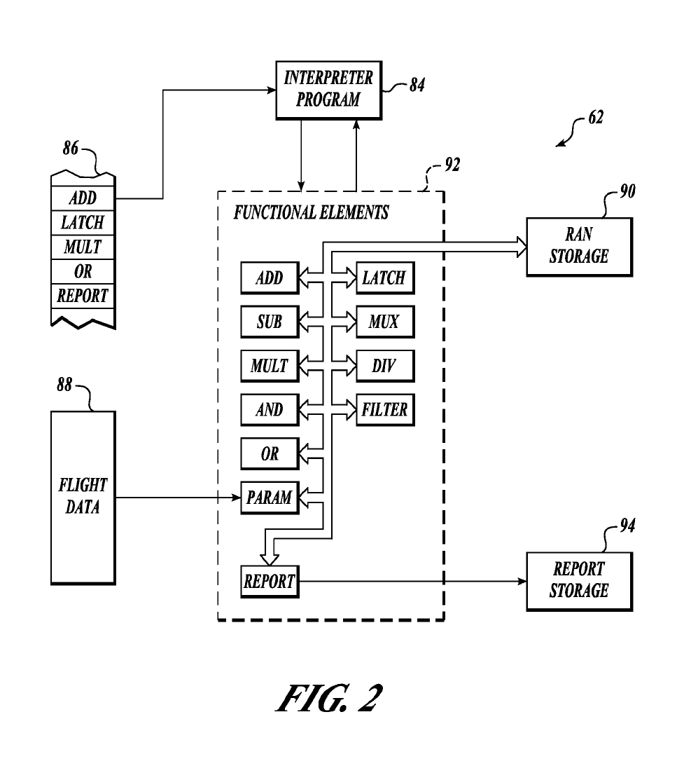

Operation of the interpreters 58 and 60 and the interpreter in the ACMF component 62 will be described in connection with FIG. 2. Preferably, all of the interpreters 58 and 60 and the interpreter in the ACMF component 62 will be essentially the same program written in C language and only modified to the extent necessary to run on different types of computer hardware. It should be noted also that the interpreter 62 is created using conventional and well known interpreter programming techniques, such as used in writing Basic interpreters. The interpreter in the ACMF component 62 includes a interpreter program 84 which accepts the RAN in the form a RAN database 86. In this case the RAN database 86 is composed of a series of codes representing functional elements which are identified in the database 86 as an ADD, a LATCH, a MULTIPLY, an OR gate and a REPORT. The functional elements which represent various types of operations such as operations on flight data are more fully described in connection with FIG. 3. Included in the depiction of the interpreter in the ACMF component 62 in FIG. 2 is flight data source 88, that in this case could be, for example, the aircraft data bus 12, and the RAN storage area 90 that would normally be located in a random access memory. In addition, a group of computer routines for executing functional elements identified as the ADD function through the REPORT function is located in memory 92. A report storage area 94 is also provided in memory for storing report data generated by the interpreter in the ACMF component 62.

During an interpreting operation the interpreter in the ACMF component 62, under control of the program 84, receives the function element codes in sequence from the database 86 and selects corresponding computer routines for the corresponding functional elements from memory 92 for execution. If the selected computer routine is for example the ADD function and requires flight data from the flight data source 88, this data is obtained by a PARAM routine from the flight data source 88. The flight data is operated on by the ADD routine and the result is stored in the RAN storage area 90. The RAN storage area 90 is also used to store other types of RAN information, such as RAN connection lines that are used to connect functional elements in the RAN, which are described in more detail in connection with FIG. 3. In many cases the last function to be performed on the RAN by the interpreter in the ACMF component 62 is the REPORT function. The REPORT element selects the appropriate information from the RAN storage area 90, formatting it and transferring it as indicated to the report storage 94 where it becomes, available for storage in recorder memory 24. In this manner, the interpreter program 84 responds to the sequence of the RAN codes from the database 86 to perform the data management operations as defined by the RAN.

FIG. 3 shows an example of one the RANs 56 as displayed on the display 40A of the development system 32. In one embodiment of the invention the network editor 54 is implemented using the Microsoft Windows® operating system and makes use of the point and click capabilities of the mouse 40C. Although the network editor 54 is described in terms of a Windows® environment, it will be appreciated that it can be implemented using other operating systems that employ graphical interfaces, such as the Apple Macintosh operating system. Here, the RAN 56 is shown as part of a network editor screen 102, which is generated by the network editor 54. In order to illustrate the operation of the ACMF 62, the RAN 56 has been constructed to exemplify an elementary operation on selected flight data. The RAN 56 includes a group of functional element symbols 104-118 which represent the type of functional element routines stored in the memory 92 of FIG. 2. In the RAN 56 these functional element symbols are: the PARAM symbol 104, which represents the flight data parameter airspeed as indicated by the letters CAS 158; the CONSTANT symbol 106, which represents a constant value equal to an airspeed of 200.00 knots; the STORAGE symbol 108 for storing the current value of airspeed; the COMPARE symbol 110 for comparing the values of two types of data; the SPLITTER symbol 112 for splitting a data input into a first output representing the value of the data and a second output representing the validity of the data; the INVERTER symbol 114 for inverting boolean logic signal; the OR gate symbol 116; the LEADING EDGE DETECTOR symbol 118 for determining if boolean data is changing from False to True; and the REPORT symbol 120 for generating a report.

In one embodiment of the invention color is used to represent the characteristics of connection lines 122-132 between the functional element symbols 104-120. For example, the connection lines 122 and 124 that connect the PARAM symbol 104 and the CONSTANT symbol 106 with the STORAGE symbol 108 and the SPLITTER symbol 110 are red to designate that floating point data values along with a boolean data validity signal are being transferred. By contrast, the connection lines 126-132 that connect the function element symbols 110-120 are black to denote that boolean true/false or validity signal is being transferred. The red connection lines 122 and 124 are indicated by solid lines and the connection lines 126-132 are indicated by dotted lines. In addition to red and black, other colors can be used to indicate different types of data such as blue for integer values and yellow for character strings. Various combinations between colors and data type may be used. Each of the function element symbols 104-120 has at least one input port or one output port or both input and output ports to which the connection lines 122-132 can be drawn. For example, the PARAM symbol 104 has a single output port 134, the COMPARE symbol 110 has a pair of input ports 136 and 138 along with an output port 140 and the REPORT symbol 120 has a single input port 142. Preferably, the network editor program 54 will only permit connection lines, such as 122-132 to be drawn between function element symbols such as 104-120 that have the capability of receiving or processing the type of data or information indicated by the color of the lines.

Along with a conventional Windows® type tool bar 144 and a button bar 146 for editing and control functions, the network editor screen 102 includes a symbol palette 148 which includes at least the most commonly used functional element symbols, such as symbols 104-120. One of the advantages of the symbol palette 148 is that it makes it particularly convenient to construct a RAN, such as the RAN 56 by using the mouse 40C to drag and drop the functional element symbols 104-120 from the palette 148 to the desired locations on the screen 102. After the functional element symbols 104-120 are placed on the screen 102, the mouse 40C can also be used to draw the connection lines 122-132.

The object of the particular Aircraft Condition Monitoring Function defined by the RAN 56 is to generate a report when the airspeed of the aircraft 10 drops below 200 knots or if the airspeed signal becomes invalid. The operation as defined by the RAN 56 starts with the input of airspeed as indicated by the PARAM symbol 104, which is then transmitted as shown by the connection line 122 to storage as indicated by the STORAGE symbol 108 and to a signal SPLITTER represented by the SPLITTER symbol 112. Along with airspeed, a constant representing 200 knots is applied, as indicated by the connection line 124, from a constant signal source identified by the CONSTANT symbol 106 to a comparator as represented by the COMPARE symbol 110. If the airspeed drops below 200 knots, the comparator as indicated by the connection line 128 will output a boolean true signal to an OR gate corresponding to the OR gate symbol 116. The splitter corresponding to the SPLITTER symbol 112 will output, as indicated by the connection line 126, a boolean validity signal representing the validity portion of the airspeed signal to an inverter corresponding to the INVERTER symbol 114. The inverted validity signal as indicated by the connection line 127 is also applied to the OR gate and the logic output of the OR gate represented by the OR gate symbol 116 is then applied to the leading edge detector corresponding to the DETECTOR symbol 118. As a result, if either the airspeed drops below 200 knots or if the airspeed validity becomes invalid, the detector will apply a boolean true signal as indicated by the connection line 132, to the report generator represented by the REPORT symbol 120. The report generator will then generate a report which indicates that either of these two events have happened and what the airspeed was when it happened using the data store represented by the STORAGE symbol 108.

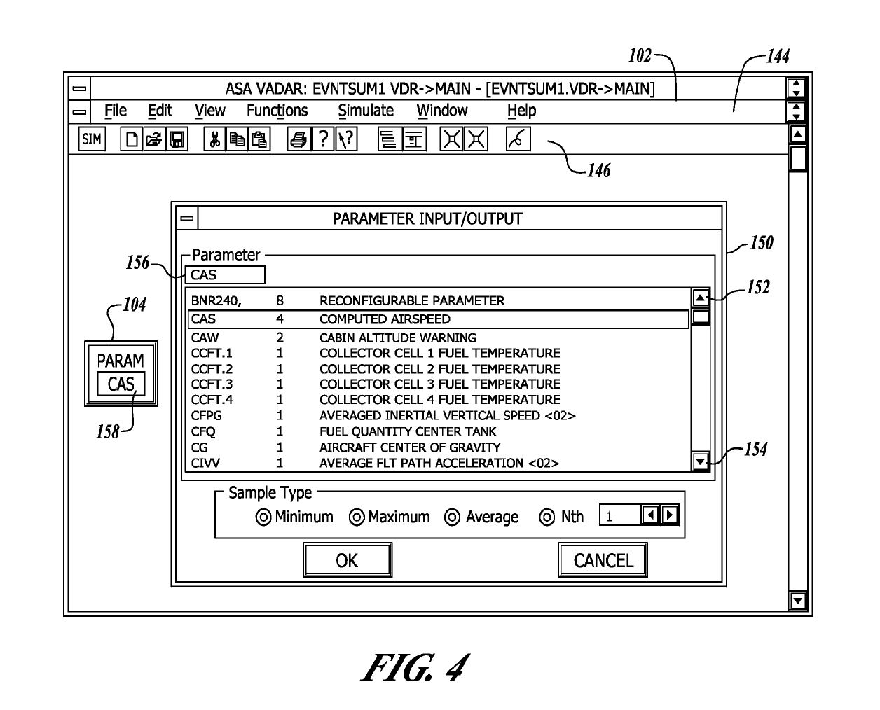

As further illustration of the features of the network editor 54, FIG. 4 provides a partial view of the screen 102 during the development of the RAN 56. In this case, after the selection of the PARAM symbol 104 from the symbol palette 148, the symbol 104 can be double clicked using the mouse 40C to display a Parameter Input/Output display window 150 which displays all of the flight data parameters which are available to the RAN 56. The flight data parameters can be scrolled in the window 150 using a pair of scroll buttons 152 and 154. The desired parameter, in this case computed airspeed as shown by the shaded portion 156 of the window, is selected by the mouse 40C for the PARAM symbol 104 and a corresponding designation “CAS” 158 is displayed in the PARAM symbol 104.

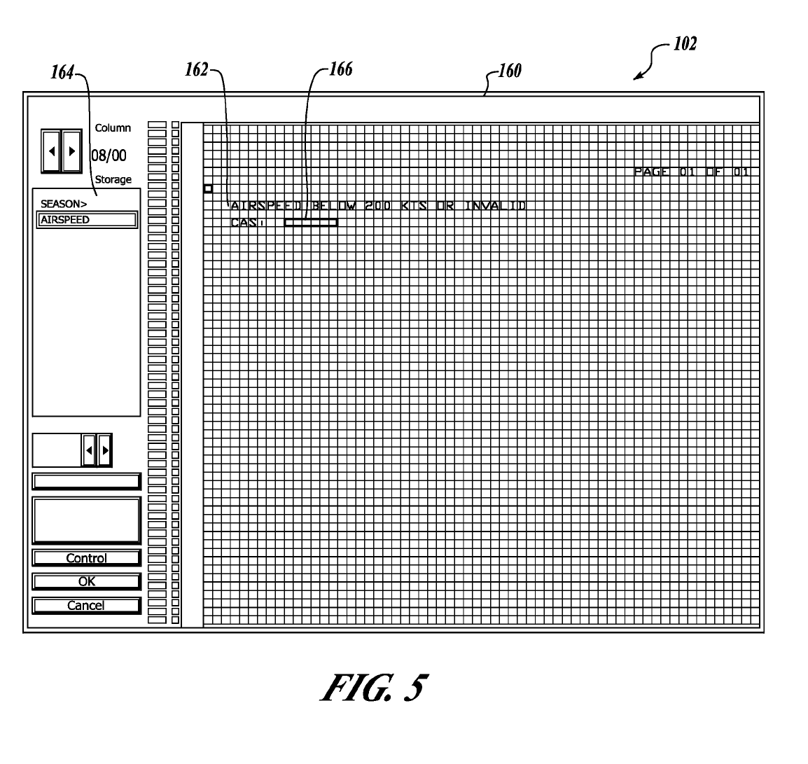

Similarly, as illustrated in FIG. 5, by double clicking on the REPORT symbol 120 a report format window 160 is displayed. Here, the keyboard 40B can be used to type in the text of the report as indicated at 162. Displayed in a list 164 in the left hand portion of the report format window 160 are the flight parameters or other values stored by the RAN 56, such as airspeed stored in the STORAGE symbol 108. By highlighting the desired value in the list 164, and then designating a location in the report format using the mouse 40C, this value or flight parameter can be placed in the report as shown, for example, by a shaded word “airspeed” 166 in the report format 160.

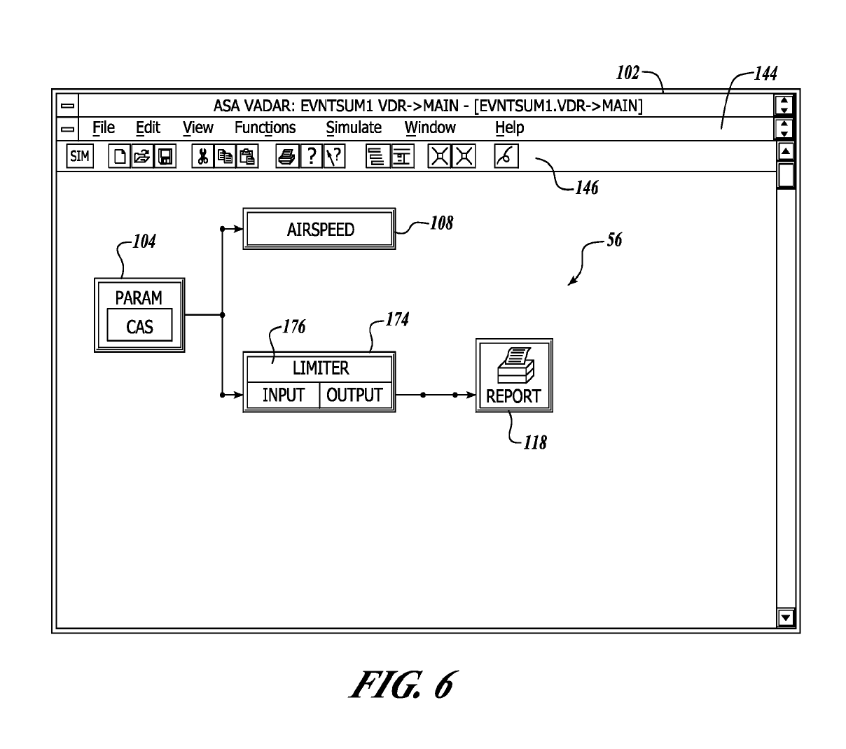

Another embodiment of the invention, which is illustrated in FIGS. 3 and 6, is the ability of the network editor 54 to compress a RAN into a functional element in a higher level RAN. With reference to the RAN 56 in FIG. 3, one method of compressing a RAN is to drag the mouse 40C over the function element symbols 106, 110, 114, 116 and 118 that are to be included in a compressed RAN indicated by 168. A dashed outline 170 surrounding the compressed RAN 168 will be displayed on the screen 102 along with a collapse region option box 172. If the compressed RAN 168 within the dashed outline 170 is satisfactory, then the “yes” button in the option box 172 is clicked and the RAN 56 is displayed on screen 102 in the form shown in FIG. 6. Here, the compressed RAN 168 is displayed as a functional element symbol 174 with a name “LIMITER” 176. In this manner, it is possible to construct a hierarchy of compressed RANs so that a very complex RAN can be displayed on one screen such as screen 102.

It will be appreciated that method of creating reconfigurable algorithmic networks, RANs 56, using the above described visual programming techniques, which can be implemented using conventional Windows® programming methods, provides a very powerful and flexible way of managing and using the large amounts of flight data that are available in commercial aircraft 10. Not only can RANs 56 be easily created and debugged, but they can be modified to suit new requirements with minimal effort. In addition, because the RANs 56 are interpreted, they can be executed on a variety of computer systems without reprogramming.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A data management system comprising:
a) a plurality of flight data sources for generating a plurality of flight data;
b) an avionics unit;
c) transmittal means for transmitting at least a portion of said flight data from said flight data sources to said avionics unit;
d) a reconfigurable algorithmic network, resident on said avionics unit configured to define one or more predetermined operations on predetermined flight data, said reconfigurable algorithmic network comprising:
1) a plurality of functional elements, each of said functional elements defining one or more of said predetermined operations; and
2) a database comprising:
a) a plurality of codes defining one or more of said functional elements,
b) a plurality of computer routines for executing said functional elements, and
c) connection means for directing logic flow and data flow between said functional elements; and
e) interpreter means, resident on said avionics unit for interpreting said set of flight data in accordance with said reconfigurable algorithmic network, said interpreter means including connection means for defining operational relationships between said functional elements, wherein said interpreter means receives said functional element codes from said data base and selects one of said computer routines.

2. The system of claim 1, further comprising:
development means, having a display, for developing said reconfigurable algorithmic network wherein said algorithmic network is visually represented on said display with a plurality of element symbols representing said functional elements and a plurality of connection lines representing said connection means.

3. The system of claim 2, wherein said development means includes a set of functional element symbols displayed on said display and user interface means for selecting said element symbols from said set of functional element symbols and for connecting said element symbols with said connection lines.

4. The system of claim 3, wherein said user interface means includes mouse means for selecting said element symbols from said set of functional element symbols and drawing said connection lines.

5. The system of claim 4, wherein said connection lines are represented by a plurality of colors on said display and wherein said colors represent data types.

6. The system of claim 4, wherein at least one of said functional element symbols is an aircraft parameter symbol which represents said flight data parameters.

7. The system of claim 6, wherein said user interface means includes parameter display means for displaying a list of said flight data parameters on said display and said display operator input means includes selection means for associating a parameter from said list with one of said element symbols on said display.

8. The system of claim 2, wherein said development means includes simulator means for simulating the operation of said reconfigurable algorithmic network.

9. The system of claim 8, wherein said simulator means includes a simulator interpreter for interpreting said reconfigurable algorithmic network.

10. The system of claim 9, wherein said simulator means includes a simulated set of flight data for use as said flight data parameters in interpreting said reconfigurable algorithmic network.

11. The system of claim 1, wherein one of said functional elements is a report element which defines a format of a data report and when said data report is to be generated by interpreting said reconfigurable algorithmic network.

12. The system of claim 1, wherein said computer is located on the ground, one of said functional elements is a report element, and said interpreter generates a data report for at least a portion of said flight data.

13. The system of claim 1, wherein said system includes a flight data recorder located in the aircraft, the flight data recorder includes said interpreter and said reconfigurable algorithmic network, said transmittal means additionally transmits at least a portion of said flight data to said flight data recorder and said interpreter interprets said reconfigurable algorithmic network.

14. A data management system for use with aircraft having a plurality of flight data sources for generating a plurality of flight data, the data management system comprising:
a) an avionics unit receiving at least a portion of the flight data from the flight data sources;
b) a reconfigurable algorithmic network, resident on said avionics unit, that defines a set of predetermined operations on a predetermined set of said flight data, said reconfigurable algorithmic network including:
1) a plurality of functional elements, each of said functional elements defining at least one of said predetermined operations; and
2) said predetermined operations including a compressed reconfigurable algorithmic network;
c) an interpreter, resident on said avionics unit, said interpreter interpreting said set of flight data in accordance with said reconfigurable algorithmic network and defining operational relationships between said functional elements; and
d) a plurality of computer routines, resident on said avionics unit, for executing said functional elements.

15. The system of claim 14, wherein one of said functional elements is a report element, which defines a format of a data report, and when said data report is generated by interpreting said reconfigurable algorithmic network.

16. The system of claim 15, further comprising:
e) a display,
wherein said reconfigurable algorithmic network includes a report functional element and said interpreter generates a flight data display and sends the flight data display to the display for presentation.

17. A method of data management for use with an avionics unit the method comprising:
a) receiving at the avionics unit, a plurality of flight data from a plurality of flight data sources;
b) developing a reconfigurable algorithmic network resident on the avionics unit said reconfigurable algorithmic network defining a set of predetermined operations on a predetermined set of said flight data, said reconfigurable algorithmic network including a plurality of functional elements, each of said functional elements defining one or more of said predetermined operations; and
c) interpreting said set of flight data in accordance with said reconfigurable algorithmic network, said interpreting including:
1) receiving said functional elements from said reconfigurable algorithmic network;
2) defining operational relationships between said functional elements; and
3) selecting computer routines for executing said functional elements.

18. A data management device located in a vehicle for use with operational data received from a plurality of data sources, the device comprising:
a) a flight data recorder;
b) a reconfigurable algorithmic network, resident on said flight data recorder, that defines a set of predetermined operations on a predetermined set of the flight data, said reconfigurable algorithmic network including a plurality of functional elements, each of said functional elements defining one or more of said predetermined operations on a predetermined set of the flight data;
c) an interpreter, said interpreter receiving said functional elements from said reconfigurable algorithmic network and defining operational relationships between said functional elements for interpreting said set of flight data in accordance with said reconfigurable algorithmic network; and
d) an input/output device for receiving the flight data and for transferring information to and from the vehicle.

19. The system of claim 14, wherein the avionics unit includes a flight data recorder.

20. The method of claim 17, wherein the avionics unit includes a flight data recorder.
